(19) United States
(12) Patent Application Publication
(10) Pub. No.: US 2015/0350170 A1
(43) Pub. Date: Dec. 3, 2015

(54) Secure authentication of mobile users with no connectivity between authentication service and requesting entity

(71) Applicants: Jonathan Roselle, San Francisco, CA (US); John C. Chiladakis, Davis, CA (US); Jaime A. Williams, Oakland, CA (US)

(72) Inventors: Jonathan Roselle, San Francisco, CA (US); John C. Chiladakis, Davis, CA (US); Jaime A. Williams, Oakland, CA (US)

(21) Appl. No.: 14/291,456

(22) Filed: May 30, 2014

(51) Int. Cl. H04L 29/06

(52) U.S. Cl. CPC H04L 63/061; H04L 63/0428

(57) ABSTRACT

A method and system for secure authentication of a mobile device user in the absence of a connection between the authentication service and the entity that is requesting authentication. A mobile device scans and decodes a signal that is presented as a challenge whereby the mobile device obtains response requirements of the challenge. The mobile device transmits encrypted and signed response information to the authentication service for authentication, re-encryption and transmission to the presenting device as an encrypted, authenticated response to the initial challenge.

### TECHNICAL FIELD

The invention relates to the field of secure authentication systems. More specifically, the invention relates to utilizing optically recognizable symbols for secure and scalable authentication of mobile users.

### BACKGROUND

Over the last decade the need to rapidly, efficiently and securely authenticate the identity of individuals has become widespread. Secure authentication needs span everyday life in a multiplicity of uses including logging into electronic systems such as automated bank teller machines and purchasing wholesale or retail items with credit instruments. While traditional authentication of individuals is done through pin numbers, passwords and identification cards, there is an ever present need to increase the efficiency, convenience and security of these authentication systems.

The current ubiquitous use of mobile devices has created a practical environment that allows for the use of an efficient consolidated method and system for securely authenticating individual users of these devices over wireless networks.

Published prior art for mobile device authentication relies upon establishing a connection between the entity that is requesting authentication, and the authentication service. This prior art is often not practical for large-scale implementation because the prior art requires millions of simultaneous new connections and large amounts of bandwidth resulting in unmanageable resource demands.

The present invention provides a method and system that substantially improves the methods and systems presented in prior art, and satisfies the need.

### SUMMARY

Various systems, computer program products, and methods for authenticating mobile users are described herein.

According to various implementations of the invention, the method may include a plurality of operations for authenticating mobile device users. In some implementations, an entity that may require secure authentication utilizes components of this system to create a optical authentication symbol as a challenge wherein the symbol may encode the identity of the host that presents the symbol, the identity of the entity requiring authenticated users, business action information required of the user such as a login request or a purchase price, and a date and time at which the symbol was created. The operations may further include, utilization of the camera and components of this system on the mobile device to decode the symbol, construct a payload that may contain personal information, digitally sign the payload and encrypt the payload. Components of the system on the mobile device may send the encrypted payload to the authentication components of this system whereby the authentication components may utilize public and private encryption keys to decrypt and validate the payload. The operations may further include, components of the authentication system re-encrypting the payload and establishing a connection to the presenting host and not to the requesting entity. The presenting host may submit the re-encrypted payload to the requesting entity as a response to the initial challenge, utilizing the existing connection where components of this system may be utilized to decrypt the authenticated payload.

### BRIEF DESCRIPTION OF THE DRAWINGS

The accompanying drawings, which are incorporated into and constitute a part of this specification, illustrate one or more examples of implementations of the invention.

Referring now to the drawings in which like reference numbers represent corresponding parts throughout: aspects of the invention.

FIG. 1 is a logical system component diagram illustrating an embodiment of the present invention wherein mobile users are authenticated;

FIG. 2 is a process flow diagram illustrating an exemplary overview for practicing the present invention;

FIGS. 3A and 3B are process flow diagrams illustrating an embodiment of the present invention wherein the various participants and users of the system are shown; and

FIG. 4 illustrates data flow diagram illustrating an embodiment of the present invention wherein mobile users are authenticated.

Reference will now be made in detail to various implementations of the invention as illustrated in the accompanying drawings. The same reference indicators will be used throughout the drawings and the following description to refer to the same or like items.

### DESCRIPTION OF EXEMPLARY IMPLEMENTATIONS

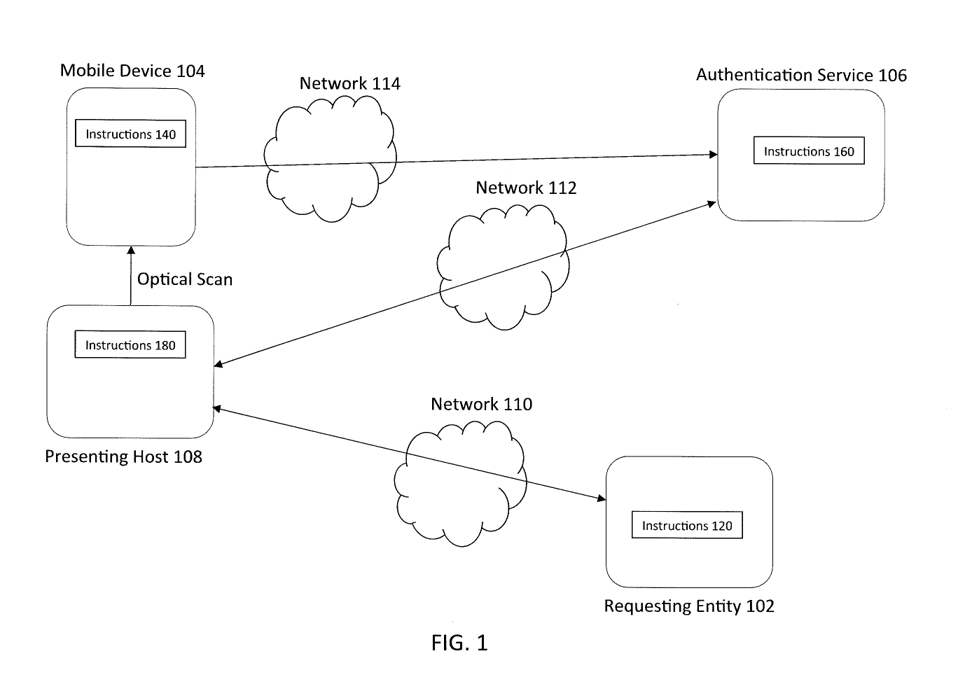

FIG. 1 is a block diagram illustrating components and information flow for a secure authentication system 100 that is configured to authenticate mobile users, according to an aspect of the invention.

In some implementations system 100 may include, among other things, requesting entity 102, mobile device 104, authentication service 106, and presenting host 108 which may each include one or more computer processors, one or more tangible (i.e., non-transitory) computer readable media, and one or more set of instructions stored on tangible computer readable media.

In some implementations requesting entity 102, presenting host 108, authentication service 106, and mobile device 104 may be connected through network 110, network 112, and network 114 which may be comprised of one or more Local Area Networks, Wide Area Networks, cellular communications networks, Public Switched Telephone Networks, the Internet, and/or other network or combination of networks.

Requesting entity 102 may be comprised of one or more computer systems requiring secure authentication for one or more purposes, and may include the purpose of enabling a secure transaction such as allowing access to an automated bank teller machine, or purchasing a retail or wholesale item. Requesting entity 102 may be configured for the generation of public and private encryption key pairs. Requesting entity 102 may further be configured to receive encrypted user authentication information from authorization service 106 via presenting host 108 through networks 112 and 118. Requesting entity 102 may also be configured to execute instructions 120 which may decrypt and act on the secure authorization request received from authorization service 106.

Authentication service 106 may be configured to securely authenticate one or more mobile users. Authentication service 106 may be comprised of one or more computer servers configured to execute instructions 160 in order to perform various functions of authentication service 106. Authentication function may include the creation of user and requesting entity profiles or accounts, storage, retrieval and encrypted transmission of mobile user authentication information, the storage, retrieval and encrypted transmission of requesting entity information and the generation of public and private encryption key pairs.

In some implementations authentication service 106 may be communicatively persistently coupled to a presenting host 108 via a computer network 112.

In some implementations, the presenting host 108 may include a computing device containing instructions 180 which may be executed in a web browser, or other device capable of creating and or presenting an optical symbol, accepting encrypted user authentication messages and transmitting encrypted user authentication messages.

In some implementations, mobile device 104 may include a computing/processing device such as a wireless phone, a personal digital assistant, a smart phone, a tablet computing device, and/or other portable computing device that may include a camera (not illustrated in FIG. 1) which may be utilized to scan an optical code presented by the presenting host 108. In some implementations, mobile device 104 may execute instructions 140 that may be utilized by a mobile user to establish an account or registration with the authentication service 106. In some implementations, the user may associate users' authentication information with the authentication server 106. During registration, the mobile device instructions 140 may prompt the user to enter his/her user id (for example, user name, or other identifier) and password into a user interface associated with the mobile device. The mobile device instructions 140 may communicate with the authentication service 106 and transmit the user name and password to the authentication service 106. The authentication service 106 may generate mobile device user metadata such as a unique user identification token, and password in a credential set at the authentication service 106. The authentication server 106 may communicate, to the mobile device instructions 140, the user identification token that references the credential set stored at the authentication service 106. The mobile device instructions 140 may store the user identification token at the mobile device 104. The password may be stored only at the authentication service 106 and not at the mobile device 104.

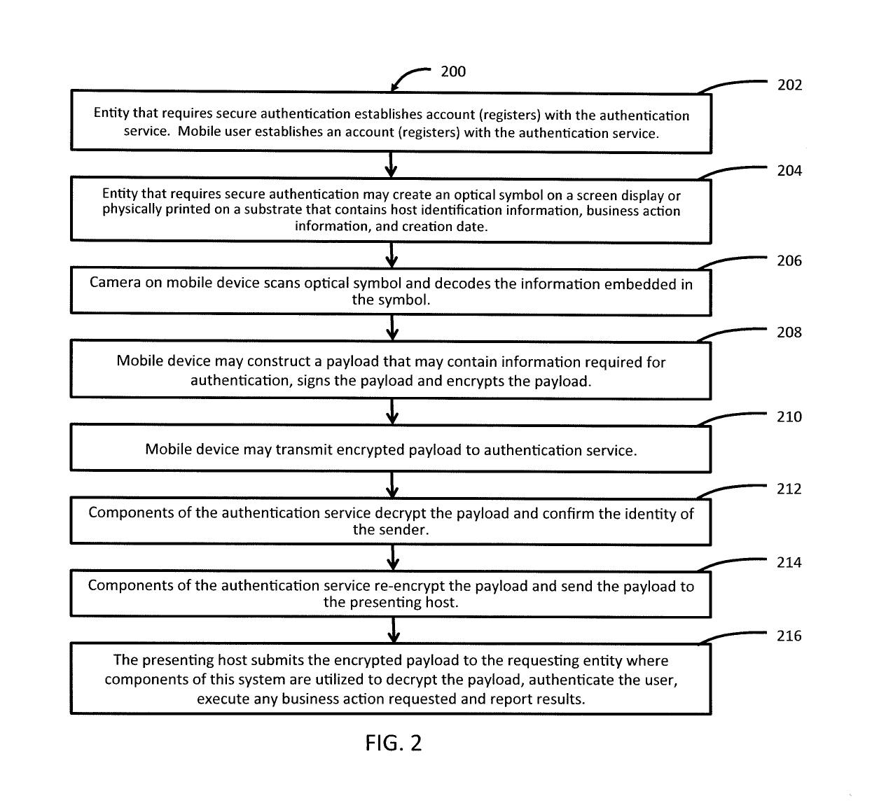

FIG. 2 is a process overview diagram illustrating the various operations of an authentication system that is configured to authenticate mobile users, according to an aspect of the invention. In some implementations, the described operations may be accomplished using one or more of the steps described herein. In some implementations, various operations may be performed in different sequences. In other implementations, additional operations may be performed along with some or all of the operations. In yet other implementations, one or more operations may be performed simultaneously. In yet other implementations, one or more operations may not be performed. Accordingly, the operations described are exemplary in nature and, as such, should not be viewed as limiting.

In an operation 202, process 200 may receive a request from requesting entity 102 to establish an account with authentication service 106. During this operation a Universally Unique Identifier (UUID) that identifies the requesting entity as well as other identifying information is stored for later authentication operations. Once established, this account may allow requesting entity 102 to utilize authentication service 106 and authenticate mobile users via their mobile device 104. Process 200 may also receive a request from mobile users via mobile device 104 to establish an account with authentication service 106. During this operation user metadata such as a user id for the mobile device user as well as other authorization information is stored for later authentication operations.

In an operation 204, requesting entity 102 may directly create or may allow for the presenting host 108 to create a visual symbol on a screen display or physically printed on a substrate that contains the presenting host 108 host identification information, business action information, and creation date.

In an operation 206, a mobile device user may utilize mobile device 104 to directly create or may allow for the presenting host 108 to create an optical symbol on a screen display or physically printed on a substrate that may contain the presenting host 108 host identification information, business action information, and/or creation date and/or other like information.

In operation 208, mobile device 104 may constructs a data payload that may contain personal information required for authentication, digitally sign the payload and encrypt the payload.

In operation 210, mobile device 104 may transmit an encrypted data containing mobile user authentication information to authentication service 106 via network 114.

In operation 212, components of the authentication service 106 may decrypt the payload and may confirm the identity of the mobile user by validating the digital signature and referencing the mobile user's identification and other information that was established during user registration.

In operation 214, components of the authentication service 106 may re-encrypt the payload utilizing the requesting entity's 102 public encryption key and send the payload to the presenting host 108.

In operation 216, components of the presenting host 108 may submit the encrypted payload to the requesting entity 102 where components of this system may be utilized by the requesting entity 102 to decrypt the payload, authenticate the user, execute any business action requested and transmit resulting information back to the presentation host 108. This information may include information of login success/failure, purchase success/failure or other business action notifications.

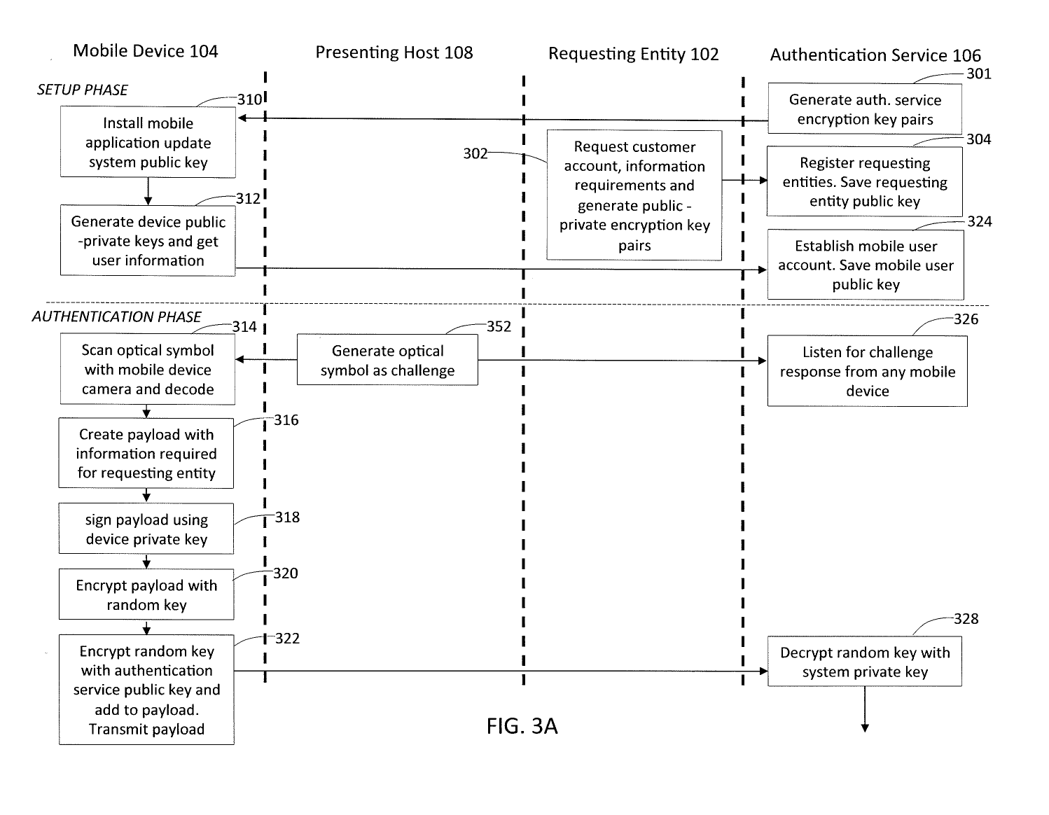

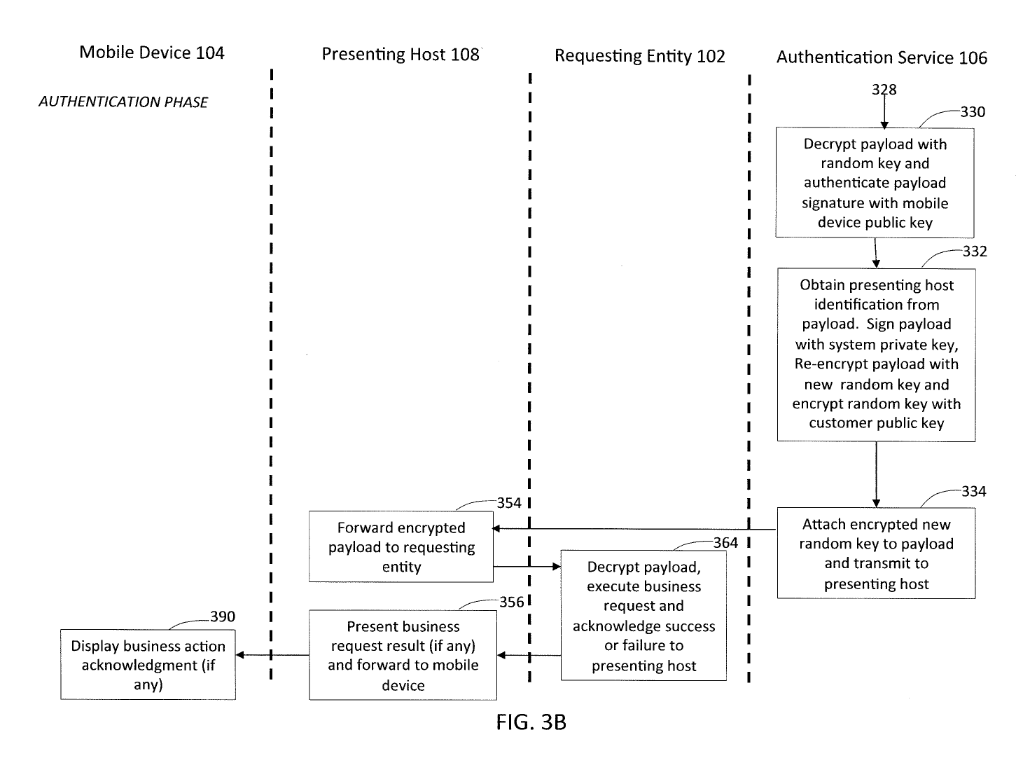

FIG. 3A and FIG. 3B are a process flow diagram illustrating a secure authentication system that is configured to authenticate mobile users, according to an aspect of the invention. In some implementations, the described operations may be accomplished using one or more of the steps described herein. In some implementations, various operations may be performed in different sequences. In other implementations, additional operations may be performed along with some or all of the operations. In yet other implementations, one or more operations may be performed simultaneously. In yet other implementations, one or more operations may not be performed. Accordingly, the operations described are exemplary in nature and, as such, should not be viewed as limiting.

Setup Phase

In the setup phase, mobile device user of mobile device 104 and requesting entity 102 may register by establishing accounts with the authentication service 106.

In operation 301, authentication service 106 may utilize instructions 160 and may generate the authentication service public and private encryption keys pair. Instructions 160 may transmit the authentication service public key to mobile device 104.

In operation 302, requesting entity 102 may establish a connection with authentication service 106 and may receive and execute instructions 120. Instruction 120 may register the requesting entity and in doing so may allow the requesting entity to enter information into an interface such as a as email address, business name Employer Identification Number as well as other information. Instructions 120 may generate the requesting entity's public and private encryption key pair. Instructions 120 may transmit registration information to authentication service 106.

In operation 304, authentication service 106 may utilize instructions 160 to save the registration information transmitted in operation 302.

In operation 310, the mobile device user may install the mobile application on mobile device 104 consisting of the mobile instructions 140 and the encryption public key from the authentication service 106. The mobile device user may execute instruction 140 and by doing so may generate the user's identification information and may enter other authentication information for example a user name, email address, password, address, telephone number and other similar identifying information.

In operation 312, mobile device 104 may generate the mobile user's public and private encryption keys pair

In operation 324, authentication service 106 may establish and save the mobile user's registration information.

Authentication Phase

In the authentication phase, mobile device user of mobile device 104 may be presented a challenge in the form of an optical symbol that may identify requesting entity 102 and may be presented by presenting host 108 whereby authentication service 106 may provide authentication confirmation back to requesting entity 102 either directly through a various networks or via the presenting host 108 through various networks.

In operation 352, presenting host 108 may generate an optical symbol as an authentication challenge. In some implementations the optical symbol may be presented on an electronic display by presenting host 108. In other implementations the optical symbol may be printed, plotted or drawn on a substrate. The optical symbol may be comprised of an optical code that may include one or more QR codes, Bar code or other optical symbol that may encode information. The optical symbol may encode information required for secure authentication including the identity of requesting entity 102, the identity of the presenting site 108, business action information required of the user such as a login request or a purchase price, and/or a date and time at which the symbol was created as well as other information required for secure authentication. Presenting host 108 may initiate and establish a network connection with authentication service 106.

In operation 326, authentication service 106 may accept a network connection from presenting host 108 and may wait for a challenge response to the request from any mobile device 104.

In operation 314, mobile device user of mobile device 104 may be presented a challenge in the form of an optical symbol. The optical symbol may encode information required for secure authentication including the identity of requesting entity 102, the identity of the presenting site 108, business action information required of the user such as a login request or a purchase price, and/or a date and time at which the symbol was created as well as other information required for secure authentication. Mobile device user may utilize the camera on mobile device 104 to scan the code and execute instructions 140 and thereby decode the information embedded within the optical symbol.

In operation 316, mobile device 104 may utilize instructions 140 to create a data payload that may be required by requesting entity 102. This data payload may include the identity of requesting entity 102, the identity of the presenting site 108, business action information required of the user such as a login request or a purchase price, and/or a date and time at which the symbol was created as well as the mobile user's authentication information such as user identification token, user name, email address, password, address, telephone number and other information required by the requesting entity.

In operation 316, mobile device 104 may utilize instructions 140 and the device user's private encryption key generated in operation 312 to create a digital signature, and add the digital signature to the data payload generated in operation 316.

In operation 318, mobile device 104 may utilize instructions 140 to generate a random encryption key and utilize the key to encrypt data payload generated in operation 316.

In operation 322, mobile device 104 may utilize instructions 140 to encrypt the random key generated in operation 318 with the authentication service 106 public encryption key generated in operation 301 and add the encrypted random key to data payload generated in operation 316. Instructions 140 may establish a connection with authentication service 106 and transmit the data payload.

In operation 328, authentication service 106 may receive the data payload transmitted in operation 322 and may utilize the authentication service 106 private encryption key generated in operation 301 and decrypt the random key attached to the data payload.

In operation 330, authentication service 106 may utilize instructions 160 and the random key decrypted in operation 328 to decrypt the data payload transmitted in operation 322. Instructions 160 may then authenticate the data payload signature generated in operation 316 with mobile device public key generated in operation 312.

In operation 332, authentication service 106 may utilize instructions 160 and parse the data payload transmitted in operation 322 to obtain presenting host 108 identification. Instructions 106 may also create a digital signature for the data payload by utilizing the authentication system 106 private key generated in operation 301. Instructions 160 generate a new random encryption key and utilize the new random key to re-encrypt the data payload transmitted in operation 322. Instructions 160 may encrypt new random key with the requesting entity 102 public key generated in operation 302.

In operation 334, authentication service 106 may utilize instructions 160 to attach the encrypted random key generated in operation 332 to the data payload encrypted in operation 332 and transmit the data payload and attached encrypted key to the presenting host 108 utilizing presenting host 108 identification decrypted in operation 332.

In operation 354, presenting host 108 may utilize instructions 180 to transmit the encrypted data payload to requesting entity 102. In operation 364, requesting entity 102 may utilize instructions 120 and requesting entity 102 private encryption key generated in operation 302 for the purpose of decrypting the random key encrypted in operation 334. Instructions 120 and the decrypted random key may be utilized to decrypt the data payload transmitted in operation 354, which may then be parsed to obtain information including the identity of requesting entity 102, the identity of presenting site 108, business action information required of the user such as a login request or a purchase price, and/or a date and time at which the symbol was created as well as the mobile user's authentication information such as UUID, user name, email address, password, address, telephone number and other information required by requesting entity 102. Instructions 120, requesting entity 102 private encryption key generated in operation 302, and the data a signature generated in operation 332 may further be used validate the authenticity of the data payload and authenticate the user and execute any business action requested for example, a secure user login or a retail or wholesale purchase transaction. Requesting entity 102 may relay information related to the business action to presenting host 108.

In operation 356, presenting host 108 may display information responding to the successful or failed authentication challenge and business action request. Where the display may be shown on presenting host 108 electronic display for viewing by the authenticated mobile device user. This information may include notification information of login success/failure, purchase success/failure or other business action notifications. Presenting host 108 may utilize instructions 180 to relay information related to the business action to mobile device 104.

In operation 390, the mobile device 104 may utilize instructions 140 to display information related to the business action to the authenticated mobile device user.

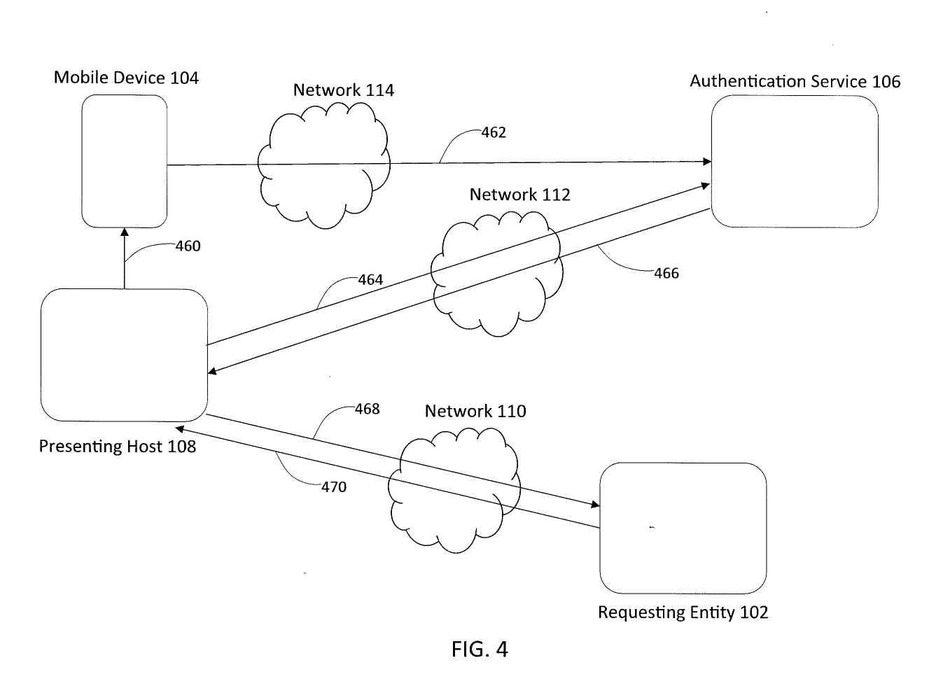

FIG. 4 depicts an exemplary data flow diagram illustrating process relationships in a system executing secure authentication of mobile device users. Accordingly, the data flows described are exemplary in nature and, as such, should not be viewed as limiting.

In data flow 460, presenting host 108 may present an optical symbol as an authentication challenge as is described in operation 352. Information encoded in the optical symbol may be transmitted through optical scanning from the presenting host 108 to the mobile device 102.

In data flow 464, presenting host 108 may establish a connection with authentication service 106 and may transmit identifying information about presenting host 108. The connection would allow authentication service 106 to await a challenge response from a mobile device 104.

In data flow 462, mobile device 104 may transmit an encrypted data payload to authentication service 106 as a challenge response. This data payload may include the identity of requesting entity 102, the identity of the presenting site 108, business action information required of the user such as a login request or a purchase price, and/or a date and time at which the symbol was created as well as the mobile user's authentication information such as the user's unique identification number, user name, email address, password, address, telephone number and other information required by the requesting entity.

In data flow 466, authentication service 106 may transmit an authenticated and re-encrypted data payload to presenting host 108 that may contain the information described in data flow 462.

In data flow 468, presenting host 108 may forward the authenticated and re-encrypted data payload described in data flow 466 to requesting entity 102.

In data flow 468, presenting host 108 may transmit the authenticated and re-encrypted data payload described in data flow 468 to requesting entity 102.

In data flow 470, requesting entity 102 may transmit information responding to the successful or failed authentication challenge and business action request. This information may include notification information of login success/failure, purchase success/failure or other business action notifications.

Implementations of the invention may be made in hardware, firmware, software, or various combinations thereof. Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method for authenticating mobile device users, the method comprising:
generating by a presentation host an authentication challenge; the authentication challenge being encoded using optical encoding that is configured to be decoded based on an optically captured representation of the authentication challenge;
communicating, by the presentation host, a notice of the presentation of an authentication challenge to the authentication service;
receiving, by an authentication service, a notice of the presentation of an authentication challenge from a presentation host separate from the authentication service, wherein the notification is associated with a presentation host;
optically displaying, by the presentation host, the authentication challenge to the mobile device;
decoding by a mobile device associated with a mobile user an optically captured representation of the authentication challenge containing the identity of the presenting host and optional business action information;
generating by a mobile device associated with a mobile user an encrypted data payload that contains unique metadata about the user, the identity of requesting entity as obtained from the authentication challenge, the identity of the presenting host as obtained from the authentication challenge, business action information as obtained from the authentication challenge;
communicating, by a mobile device associated with a mobile user, an encrypted and digitally signed data payload and encrypted key to the authentication service;
receiving, by the authentication service, the encrypted data payload and an encryption key wherein the encrypted data payload is decrypted;
verifying, by the authentication service, the validity of the mobile device user by matching the user metadata to data saved on a registered users list;
communicating, by the authentication service, an encrypted and digitally signed data payload and encrypted key to the presenting host;
receiving by the presenting host, an encrypted data payload and an encrypted key;
communicating, by the presenting host, an encrypted data payload and an encrypted key to the requesting entity;
receiving by the requesting entity an encrypted data payload and an encryption key wherein the payload is decrypted, parsed and business action information in the payload is utilized;
And communicating, by the authentication server, the resulting business action to the mobile device.

2. The method of claim 1, wherein the authentication code is generated by instructions on the presenting host whereby the authentication code comprises one or more identifiers that identify the presenting host and business action information associated with the authentication challenge;

3. The method of claim 1, wherein the data payload generated by the mobile device is digitally signed by the mobile device using a private key of the public/private encryption key pair generated by the mobile device;

4. The method of claim 1, wherein the data payload generated by the mobile device is encrypted for transmission from the mobile device to the authentication service utilizing a randomly generated key wherein the key is further encrypted using a the public key of the public/private encryption key pair generated by the authentication service;

5. The method of claim 4, wherein the encryption key for the data payload received by the authentication service is decrypted using the private key of the public/private encryption key pair generated by authentication service;

6. The method of claim 5, wherein the data payload received by the authentication service is decrypted using the decrypted randomly generated key;

7. The method of claim 6, wherein the data payload received by the authentication service is digitally signed by the authentication service using a public key of the public/private encryption key pair generated by the requesting entity;

8. The method of claim 7, wherein the data payload decrypted by the authentication service is encrypted for transmission from the authentication service to the presenting host utilizing a randomly generated key wherein the key is further encrypted using a the public key of the public/private encryption key pair generated by the requesting entity.

9. An authentication system comprising:
A presentation host configured to generate and display an optically encoded authentication challenge and to receive and forward encrypted challenge responses to the requesting entity;
A mobile device, utilized by a mobile device user, configured to optically scan the authentication challenge, encrypt and transmit a challenge response to an authentication service;
An authentication service configured to receive the encrypted challenge response transition, authenticate the user and transmit an encrypted payload to the presentation host;
And a requesting entity configured to receive an encrypted challenger response from the presentation host and utilize the encrypted payload to execute business functions.

10. The presentation host of claim 9 wherein the presentation host contains a software application executed by a processor to generate an optically encoded authentication challenge which contains identification information for the presenting host and optional business action information;

11. The presentation host of claim 9 wherein the presentation host contains instructions configured to establish a connection for communicating with the requesting entity;

12. The presentation host of claim 9 wherein the presentation host is configured to establish a connection for communicating with the authorization service;

13. The presentation host of claim 9 wherein the presentation host is configured to establish a connection for communicating with the requesting entity;

14. The presentation host of claim 9 wherein the host contains a visual display for optically communicating an encoded authentication challenge to a mobile device;

15. The mobile device of claim 9 wherein the mobile device contains a camera and a software application executed by a processor to receive and decode an image of an optically encoded authentication challenge;

16. The mobile device of claim 9 wherein the mobile device is configured to establish a connection for communicating with the authorization service;

17. The mobile device of claim 9 wherein the mobile device contains memory storing a public and private key pair uniquely identifying a the mobile device user;

18. The mobile device of claim 9 wherein the mobile device contains a software application executed by a processor configured to assemble, encrypt and transmit a data payload that contains identifying information about the device user, and optional business action information to the authentication service;

19. The authentication service of claim 9 wherein a server in the authentication service contains memory storing a public key uniquely identifying the mobile device user;

20. The authentication service of claim 9 wherein a server contains instructions executed by a processor to receive, parse and decrypt a data payload from a mobile device wherein the data payload contains identifying information about the device user and optional business action information;

21. The authentication service of claim 9 wherein a server in the authentication service contains memory storing a public key uniquely identifying the requesting entity;

22. The authentication service of claim 9 wherein a server contains instructions executed by a processor to re-encrypt and forward data payloads that are received from mobile devices to requesting entities;

23. The requesting entity of claim 9 wherein a host contains instructions executed by a processor to decrypt data payloads that are received from presenting hosts.
